(19) United States
(12) Patent Application Publication
(10) Pub. No.: US 2003/0222769 A1
(43) Pub. Date: Dec. 4, 2003

(54) System, interface, and method for two-way cellular control of automobile electrical systems

(76) Inventor: Kevin Mau, Hong Kong (CN)

Correspondence Address: LERNER AND GREENBERG, P.A., Post Office Box 2480, Hollywood, FL, 33022-2480, US

(21) Appl. No.: 10/159,116

(22) Filed: May 31, 2002

(51) Int. Cl. G08B 1/08

(52) U.S. Cl. 340/426.2; 340/426.11

(57) ABSTRACT

An interface and a system for interconnecting a car alarm and a wireless telephone include an alarm connector for connecting to an alarm and a mobile station connector for connecting to and sending signals to a wireless telephone connector. The wireless telephone has a memory storing a telephone number of a recipient to be notified when signaled through the connector of the wireless telephone. A processor (CPU) interconnects the alarm connector and the mobile station connector. The processor (CPU) signals the wireless telephone to dial the telephone number when the alarm is tripped and sends signals through the alarm connector to the processor (CPU).

### BACKGROUND OF THE INVENTION

1. Field of the Invention

The present invention relates to a system, interface, and method for cellular control of automobile electrical systems. Cellular telecommunications is one of the fastest growing telecommunications applications ever. Today, it represents a large and continuously increasing percentage of all new telephone subscriptions.

Car alarms are well known. In fact, they are so ubiquitous that passersby ignore them. Therefore, to be effective, an alarm must notify someone who does care, that is, the owner.

As a backdrop to this need, the group, European Telecommunications Standards Institute (ETSI), was established in 1982 to formulate the specifications for the Global System for Mobile Communication (GSM) digital mobile cellular radio system.

Because GSM is a globally accepted standard, the telephone can be used anywhere. In most markets, a user only must buy service from a provider and insert a card in the phone to activate. Therefore, a GSM owner can call from or be reached anywhere. The telephone contains memory for storing telephone numbers and a connector for attaching to accessories such as hands-free devices and battery chargers.

Frequently, a subscriber may desire to access and activate or deactivate electrical devices within his automobile, or other similar vehicle, such as a motor home, truck, tractor-trailer, motorcycle and boat. For example, if the subscriber has accidentally locked their keys inside the car, parked the car and then cannot remember if the headlights were turned off or if the car doors were locked, or parked the car in a large parking lot and not remembered where it was parked, the subscriber may wish to have access to various electrical systems, such as door locks, headlights, and the engine.

In addition, if the subscriber's car has been stolen, the subscriber would want to be immediately notified regardless of their location in the world. In addition, the subscriber may want to know the location of the car or alternatively, may wish to disable the car to prevent the thief from driving it.

One convenient way of accessing such electrical systems would be to dial the mobile station (MS) within the car and instruct the MS to activate or deactivate specific electrical devices.

U.S. Pat. No. 6,009,320 to Dudley discloses a Vehicle Alarm System Triggerable Wireless Phone Activation Circuit. The circuit connects to an alarm and a prior-generation wireless telephone. The wireless telephone is “prior” generation because it does not utilize its own memory to store numbers to be dialed or a connector for attaching the telephone to other systems. The circuit includes two dialing modes: pager and telephone. A power cord is provided for merely charging the wireless telephone. The circuit itself includes a keypad for entering numbers to be dialed. Memory is included to store the numbers entered on the circuit's keyboard and voice messages. An analog speaker is included, which is placed against the telephone's microphone to relay a voice message.

However, Dudley does not use GSM. Therefore, as a vehicle is moved from location to location, entirely new wireless telephones must be purchased to match local providers. Furthermore, because Dudley does not utilize the features incorporated in modern wireless phones (i.e., memory, messaging), the circuit must include unnecessary components, such as a memory unit and a keypad.

U.S. Pat. No. 6,148,212 to Park et al. discloses a System and Method for Cellular Control of Automobile Electrical Systems. The system includes an interface between a car's electrical system and a GSM capable telephone. This includes a connection to the car's alarm. More specifically, Park et al. disclose instructing a device, which is interfaced with an automobile's electrical system, to activate or deactivate specific electrical devices using the wireless network.

This is accomplished by using a mobile terminal or a unit containing the equivalent of a mobile terminal receiver, “Radio Interface Unit” (RIU), which is interconnected to a “Power Interface Unit” (PIU). The PIU directly interconnects to the automobile's electrical system and ignition.

The subscriber can then access the automobile's electrical system from any location, which reaches the mobile station, by dialing the cellular phone number or a number assigned to the RIU from another wireless or wireline phone. The RIU would then “answer” the call and receive the instructions from the subscriber for activating or deactivating specific electrical devices on the automobile.

However, the system involves a user dialing into the car. Thus, Park et al. do not disclose a system that dials a user to notify him or her that the alarm has been tripped.

U.S. Pat. Nos. 6,148,212 and 6,009,320 are hereby incorporated herein by reference in their entirety.

### SUMMARY OF THE INVENTION

It is accordingly an object of the present invention to provide a system and a method that dials a user to notify him or her that the alarm has been tripped.

A conventional vehicle alarm system does not have any mechanism for alerting a vehicle owner out of hearing range when an intruder or vehicle thief is attempting to steal the vehicle. Therefore, it would be advantageous to have a wireless phone activation mechanism/interface that can be triggered by a vehicle alarm system that could initiate a dialing sequence on a wireless phone to notify the call recipient.

It is a further object of the present invention to enable the programming of at least three different phone numbers (for example, office, home, mobile number, etc.,) and to constantly dial a series of numbers until someone actually answers the call.

In accordance with a further object of the invention, the system is initiated when the engine is shut off and the system calls the numbers indicating that the system has been activated.

Accordingly, the present invention encompasses an interface between a car alarm and a GSM capable telephone. The interface connects between a car alarm and a mobile telephone that is hidden within the car.

In accordance with a further feature of the invention, the interface connects to an output of the car alarm. The alarm transmits a signal over the output when the alarm is tripped. For alarms outputing an analog signal, the interface can include an analog-to-digital (A/D) converter that converts the analog signal to a digital signal.

In another embodiment, the wireless telephone is GSM compatible, which is a standard protocol for telephones and text messaging.

In yet another embodiment, at least three numbers may be programmed in the wireless telephone. The numbers may correspond to the subscriber's home, office, mobile telephone, or pager. The interface connects to a connector on the wireless telephone. A CPU in the interface causes a predetermined number of addresses stored in the telephone to be called.

With the foregoing and other objects in view there is provided, in accordance with the present invention, a system and method for two-way wireless control of automobile electrical systems. The system includes an interfacing device, an alarm connector coupled to the device, and a mobile station connector coupled to the device. The system further contains a mobile station coupled to the mobile station connector. The device includes a CPU, an A/D converter coupled between the CPU and the alarm connector. The CPU is further coupled to the mobile station connector.

The CPU interprets incoming signals from the alarm. In particular, the CPU is notified by the alarm when the alarm is tripped, when the alarm is armed, when the alarm is disarmed, when the car's ignition is turned off, and when power to the alarm is interrupted. In response to the incoming signals, the CPU outputs signals controlling the wireless telephone. In particular, the CPU signals the wireless telephone to dial out when the alarm outputs a signal. The CPU can cause different dialings based on different signals output by the alarm. For example, when the alarm is set, the alarm signals the CPU. The CPU can signal the wireless telephone to call a number stored in the telephone for one ring, a preset number of rings, or for a first period of time. When the alarm is triggered or another of the signals is output by the alarm, the CPU can cause a second number to be dialed for a different length of time.

The alarm connector of the interface connects to an output of the alarm. The alarm connector is constructed to complement the output of the alarm. As stated, an A/D converter may be included.

The interface connects to the electrical system of the car. A backup battery can be included. A telephone connector of the interface connects the interface to the wireless telephones. A wireless telephone has a standard connector to which the telephone connector connects. Electricity is also supplied from the interface to the wireless telephone through the telephone connector.

The system utilizes the dialer and the memory of the wireless telephone. Therefore, the inventive system is also characterized by its extremely simple construction and by avoiding the need for a keypad and memory. A very economical production is possible, since additional space is not needed for the keypad.

In the present invention, the terms “wireless telephone” and “mobile station” have been interchangeably used.

Other features which are considered as characteristic for the present invention are set forth in the appended claims.

Although the present invention is illustrated and described herein as embodied in a system and a method for two-way wireless control of automobile electrical systems, it is nevertheless not intended to be limited to the details shown, since various modifications and structural changes may be made therein without departing from the spirit of the present invention and within the scope and range of equivalents of the claims.

The construction and method of operation of the present invention, however, together with additional objects and advantages-thereof will be best understood from the following description of specific embodiments when read in connection with the accompanying drawings.

### BRIEF DESCRIPTION OF THE DRAWINGS

FIG. 1 is a schematic and block diagram of a system for wireless control of automobile electrical systems in accordance with the present invention;

FIG. 2 is a block diagram of the system for wireless control of automobile electrical systems in accordance with the present invention; and

FIG. 3 is a flowchart of a method for wireless control of automobile electrical systems in accordance with the present invention.

### DESCRIPTION OF THE PREFERRED EMBODIMENTS

In all the figures of the drawing, sub-features and integral parts that correspond to one another bear the same reference symbol in each case.

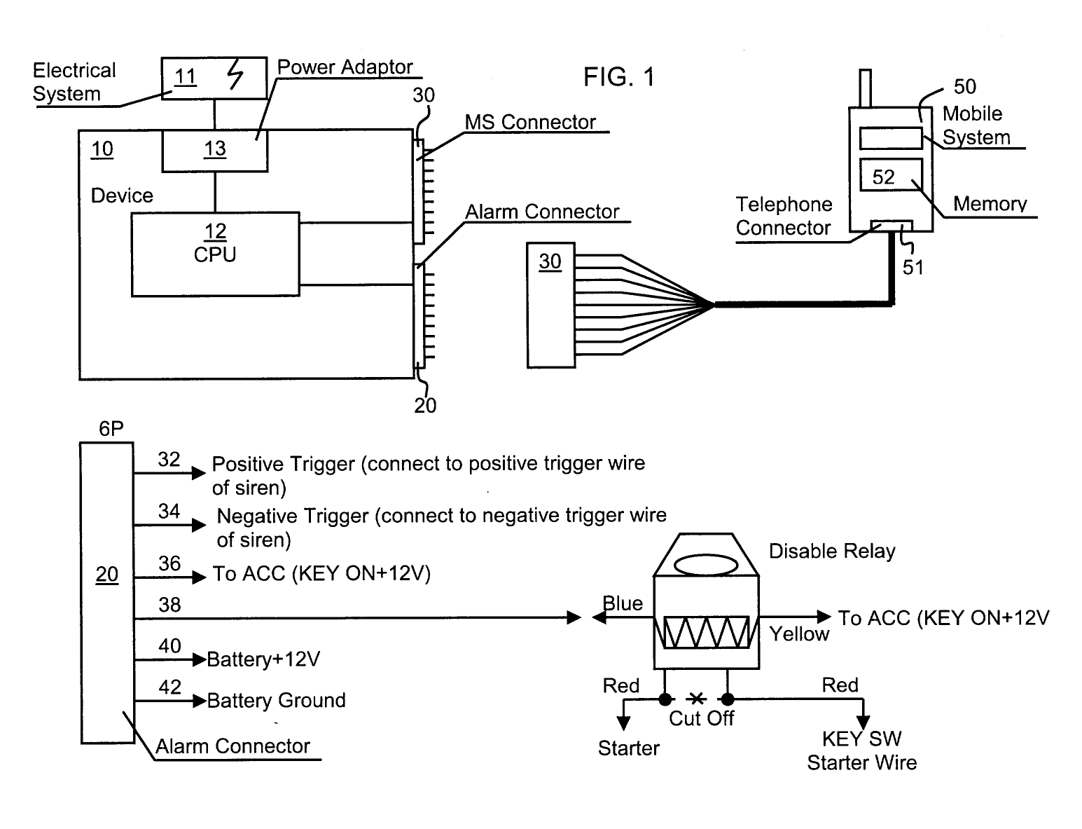

Referring now to the figures of the drawing in detail and first, particularly, to FIG. 1 thereof, there is shown an embodiment of the inventive system. The system includes an interfacing device 10 (device), a mobile station (MS) 50, an alarm connector 20 and a mobile station connector 30. The mobile station connector 30 connects to a connector 51 of the mobile station 50. The mobile station connector 30 carries signals from a CPU 12 to the mobile station 50. Electricity for charging the mobile station 50 is also supplied through the mobile station connector 30. The mobile station 50 is also programmed to contain a sequence of pre-stored telephone numbers.

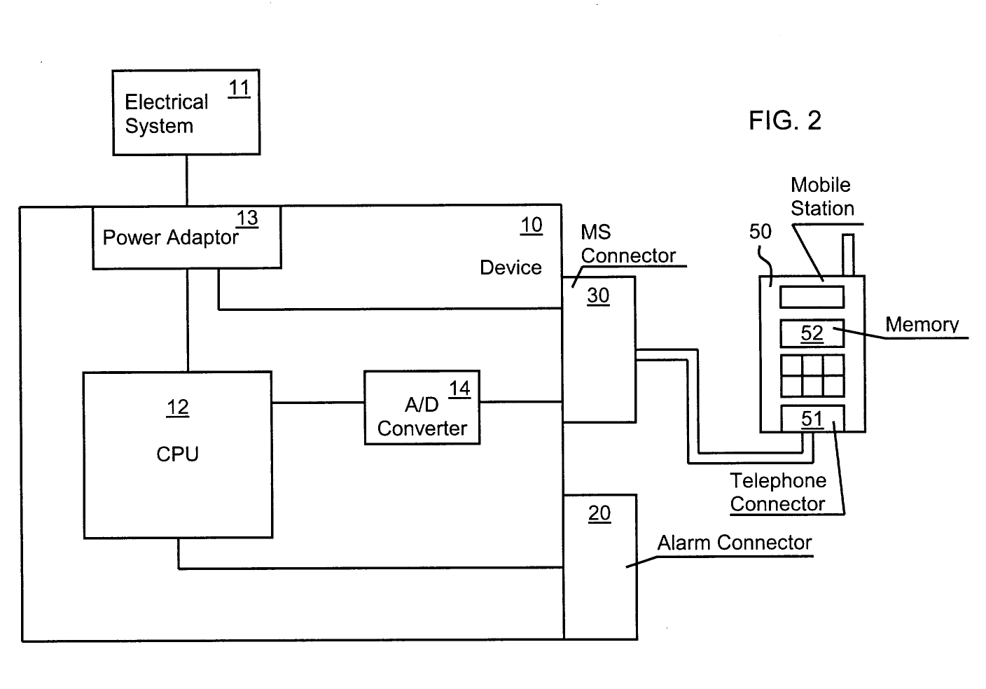

FIG. 2 shows a further embodiment of the present invention at a high-level. The system includes a device 10, an alarm connector 20 coupled to the device 10, and a mobile station connector 30 coupled to the device 10. The system further contains a mobile station 50 coupled to the mobile station connector 30. The device 10 includes a CPU 12 and an A/D converter 14 coupled between the CPU 12 and the alarm connector 20. In this embodiment analog signals are sent from the alarm to the device 10. The CPU 12 is further coupled to the mobile station connector 30.

The MS 50 has two-way communication capability and functions as an interface to the automobile's system when coupled to the device 10. The device 10 is interconnected to the electrical system 11, which activates or deactivates specific electrical devices within the automobile. Instructions to the automobile's electrical system can be sent through the device 10.

Additionally, the device 10 can be hidden within the car. Preferably, the device 10 is placed with the driver's compartment and hidden beneath the dash or within a door panel, making it undetectable to persons within the passenger section of the automobile. This can be very useful if the automobile has been stolen and the subscriber wishes to instruct the engine to turn off without alerting the thief.

Further, the CPU 12 interprets incoming signals from the alarm. In particular, the CPU 12 is notified by the alarm when the alarm is tripped, when the alarm is armed, when the alarm is disarmed, when the car's ignition is turned off, and when power to the alarm is interrupted. In response to the incoming signals, the CPU 12 outputs signals controlling the wireless telephone 50. In particular, the CPU 12 signals the wireless telephone 50 to dial out when the alarm outputs a signal.

The CPU 12 can trigger different signals/dialings based on different signals output by the alarm. For example, when the alarm is set, the alarm signals the CPU 12. The CPU 12 can signal the wireless telephone 50 to call a number stored in the wireless telephone 50 for one ring, a preset number of rings, or for a first period of time. When the alarm is triggered or another of the signals is output by the alarm, the CPU 12 can cause a second number to be dialed for a different length of time.

The alarm connector 20 of the interface connects to an output of the alarm. The alarm connector 20 is constructed to complement the output of the alarm. As stated, an A/D converter 14 may be included.

The interface connects to the electrical system 11 of the car. A backup battery or power adopter 13 can be included. A telephone connector 30 of the interface connects the interface to the wireless telephone 50. The wireless telephone has a standard connector to which the telephone connector 30 connects. Electricity is also supplied from the interface to the wireless telephone through the telephone connector 30.

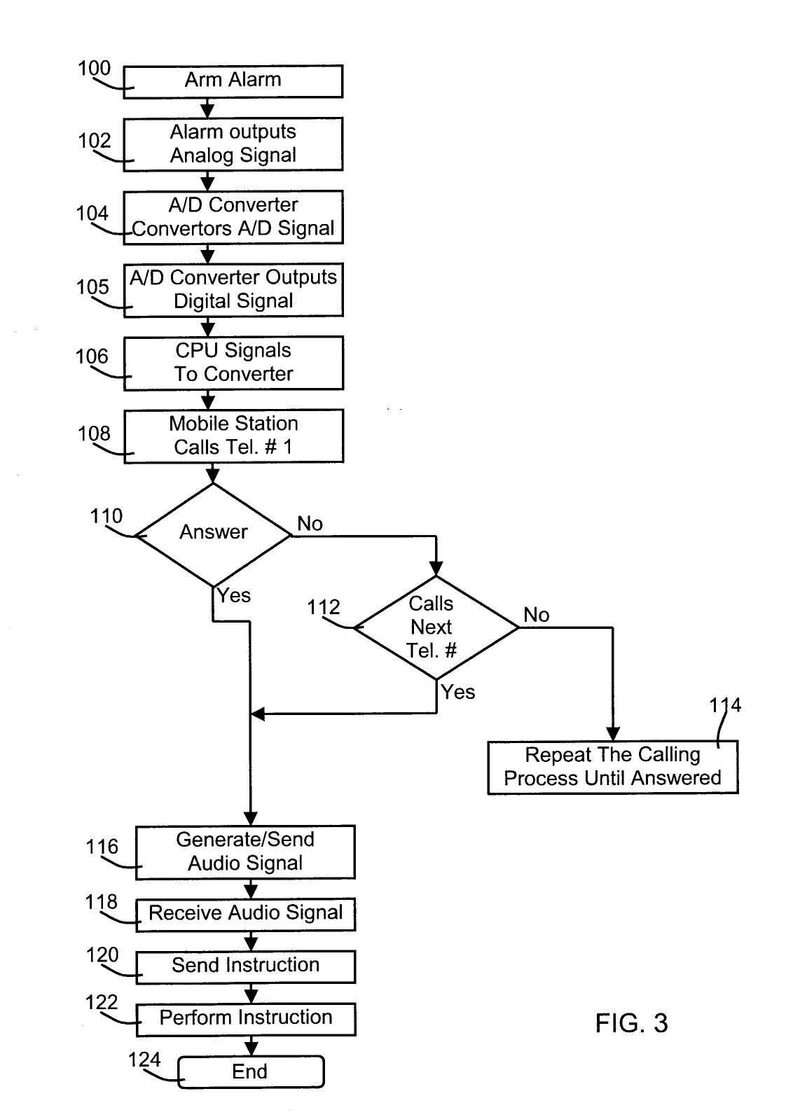

FIG. 3 shows the flow of the steps of a method for cellular control of automobile electrical systems in accordance with the present invention.

At step 100, the alarm system is armed. At step 102, the alarm outputs an analog signal to the A/D converter 14 through the alarm connector 20. At step 104, the A/D converter 14 converts the analog alarm signal to a digital signal. At step 105, the A/D converter outputs a digital signal that corresponds to the analog signal to the CPU 12. At step 106, the CPU 12 outputs an activation signal to the MS connector 30.

At step 108, the MS 50 calls the first telephone number pre-stored in the memory 52 of the MS 50. In the event that the subscriber does not answer the call within a given time or number of rings, the MS 50 calls the next pre-stored telephone number of the sequence pre-stored in the memory 32. The calling process is repeated (as shown in step 114) until the subscriber answers the call. By programming their caller ID, recipients can identify that the MS is calling. In addition, from the length of the ring, the recipient can determine what signal the alarm is sending.

When the subscriber answers the call, at step 116, an analog audio signal that corresponds to the digital audio message is generated and is sent to the subscriber indicating the status of the vehicle and the alarm. At step 118, the subscriber unit receives the audio signal. At step 120, the subscriber sends an instruction to the electrical system. At step 122, the instruction is performed by the electrical system. At step 124, the method is terminated.

In a further embodiment, if the subscriber unit is GSM capable, a text message about the alarm is sent to the subscriber unit. Then, the subscriber can respond to the interface to turn it off.

In a further embodiment, the owner stores the telephone number of the mobile station in their telephone's memory. Then the alarm is identified by crossindexing the mobile station lo's telephone number with the name stored in the owner's caller id.

Thus, it is inventively possible to trigger an alarm signal, which is sent to an interfacing device that calls a mobile station through an MS connector.

Since it is possible to forgo an expensive and complicated keypad, the inventive system can be realized in a rather simple form. The present invention is particularly suitable for use in motor vehicles because of stringent space requirements.

I claim:

1. An interface for interconnecting a car alarm and a wireless telephone having a telephone connector and a memory storing a telephone number, the interface comprising:
an alarm connector for connecting to the alarm;
a mobile station connector for connecting to and sending signals to the telephone connector; and
a processor (CPU) interconnecting said alarm connector to said mobile station connector, said processor (CPU) signaling the wireless telephone to dial a stored telephone number of a recipient to be notified when signaled through the wireless telephone connector if the alarm is tripped and to send signals through said alarm connector to said processor (CPU).

2. The interface according to claim 1, further comprising:
an A/D converter coupled between said CPU and said alarm connector for converting analog signals to digital signals.

3. The interface according to claim 1, further comprising:
a power adapter coupled between a car electrical system and said mobile station connector for providing electricity.

4. The interface according to claim 1, wherein said CPU dials a given set of numbers in series when the alarm is triggered.

5. The interface according to claim 1, wherein said CPU provides a plurality of signals each corresponding to a different call length.

6. The interface according to claim 1, wherein said CPU signals the wireless phone to ring the stored numbers until answered.

7. The interface according to claim 1, wherein said CPU signals the wireless phone to ring when the alarm is armed.

8. A telecommunications system for interfacing with an electrical system within a vehicle using a cellular network, said telecommunications system comprising:
an alarm connector;
an interface within said vehicle coupled with said electrical system, said interface including a processor (CPU) and an A/D converter coupled between said CPU and said alarm connector;
a mobile station connector coupled to said CPU; and
a mobile station having a memory storing a number to be triggered by said CPU in said cellular network, coupled to said mobile station connector.

9. The telecommunications system according to claim 8, wherein said mobile station is GSM compatible.

10. A telecommunications system for interfacing with an electrical system within a vehicle using a cellular network, said telecommunications system comprising:
an alarm connector outputting an analog alarm signal;
an interface within said vehicle coupled to said electrical system, said interface including a CPU and an A/D converter coupled between said CPU and said alarm connector, said A/D converter converting the analog alarm signal to a digital signal; and
a mobile station connector coupled to said CPU for receiving an activation signal from said CPU, said mobile station connector further coupled to a mobile station in said cellular network causing the mobile station to call a first pre-stored telephone number and repeat the calling until answered.

11. The telecommunications system according to claim 10, wherein the mobile station is GSM compatible.

12. A method for interfacing with an electrical system within a vehicle using a cellular telecommunications system, said method comprising the steps of:
providing an adapter connected to a car alarm and a mobile station;
prestoring a telephone number in the mobile station;
outputting an alarm signal with the car alarm;
receiving the alarm signal in the adapter;
outputting an activation signal with the adapter to the mobile station; and
calling the telephone number pre-stored in the mobile station.

13. The method according to claim 12, which further comprises:
pre-storing a plurality of numbers in the mobile station; and
signaling the mobile station with the adapter to call the plurality of numbers pre-stored in the mobile station in series for a given amount of time.

14. The method according to claim 12, which further comprises:
providing an analog-to-digital converter in the adapter; and
converting analog signals from the car alarm to digital signals with the analog-to-digital converter.

15. The method according to claim 12, which further comprises:
providing an owner telephone having an owner telephone number and a memory;
storing a telephone number of the mobile station in the memory of the owner telephone;
storing the owner telephone number in the mobile station;
dialing the owner telephone number with the mobile station after the adapter is signaled by the alarm; and
identifying the mobile station on the owner telephone number by cross indexing the mobile station telephone number stored in the owner telephone memory.
